(19) United States
(12) Patent Application Publication
(10) Pub. No.: US 2021/0326835 A1
(43) Pub. Date: Oct. 21, 2021

(54) GEOFENCED NOTIFICATION OF AN INVENTORY ITEM

(71) Applicant: Capital One Services, LLC, McLean, VA (US)

(72) Inventors: Stewart YOUNGBLOOD, Allen, TX (US); Staevan Alan DUCKWORTH, The Colony, TX (US); Daniel Andrew MARTINEZ, Plano, TX (US); William HARDIN, Dallas, TX (US); Amit Ramesh DESHPANDE, McKinney, TX (US); Jeffrey David WHALEN, Little Elm, TX (US)

(73) Assignee: Capital One Services, LLC, McLean, VA (US)

(21) Appl. No.: 16/849,362

(22) Filed: Apr. 15, 2020

(51) Int. Cl. G06Q 20/32; G06Q 10/08; G06Q 20/36; H04L 29/08; H04W 4/021; H04W 4/02; H04W 4/029

(52) U.S. Cl. CPC G06Q 20/3224; G06Q 10/087; G06Q 20/36; H04W 4/029; H04W 4/021; H04W 4/023; H04L 67/26

(57) ABSTRACT

Disclosed herein are system, method, and apparatus for pushing a notification corresponding to an inventory item of interest when a geofence is broken. The method includes identifying an inventory item of a plurality of inventory items as the inventory item of interest. The method includes determining a physical location of a user equipment (UE) is within a preconfigured threshold distance from a location of the inventory item of interest. The method includes based on the determining, providing an indication including the location of the inventory item of interest and the inventory item of interest. The method includes based on a response to the indication, receiving a pass including a prequalification status to complete a transaction associated with the inventory item of interest.

### BACKGROUND

A user plans many of their activities online using a mobile device. One such activity is vehicle purchasing, in which the user may browse various vehicles at various car dealers, and save one or more vehicles which the user is interested in exploring further. While the user is is in the vicinity of the dealership having a vehicle of interest, the user may remain unaware of it and may not visit the car dealer as a result. Further, the user does not receive any information about other available vehicles that the user may like to explore at the car dealer in the vicinity of the user's geographic location. Accordingly, there is a improvement need to provide up-to-date information about vehicles that the user may be interested in exploring further.

### SUMMARY

Embodiments provide notifications of an inventory item of interest to a user when the user operating user equipment breaks a geofence. In one embodiment, a method is disclosed that includes identifying an inventory item of a plurality of inventory items as an inventory item of interest. The method includes determining a physical location of a user equipment (UE) is within a preconfigured threshold distance from a location of the inventory item of interest. The method includes based on the determining, providing an indication comprising the location of the inventory item of interest and the inventory item of interest. The method includes based on a response to the indication, receiving a pass including a prequalification status to complete a transaction associated with the inventory item of interest.

The method may also include storing the received pass in a mobile wallet on the UE for a predetermined time duration. The method may also include based on the response to the indication, authenticating a user of the UE to receive the pass from an application server. The method includes providing the pass and one or more actions associated with the pass on a display of the UE. The method may also include receiving the pass as a machine-readable image. The method may also include receiving a second pass, including a prequalification status corresponding to a second inventory item of interest to complete a transaction associated with the second inventory item of interest.

The method may also include sending a type of the response to the indication and a time difference between the displaying the indication and the response to the indication to an application server. The method may also include retrieving physical location information of the inventory item of interest from an application server and monitoring the physical location of the UE using a location-based service to determine whether UE is within the preconfigured threshold distance of the location of the inventory item of interest. For providing the indication, the method may further include in response to determining that the UE is within the preconfigured threshold distance of the location of the inventory item of interest, communicating to an application server the physical location of the UE to cause the application server to trigger pushing of the indication to the UE.

System and computer-readable medium embodiments are also disclosed.

### BRIEF DESCRIPTION OF THE DRAWINGS/FIGURES

The accompanying drawings are incorporated herein and form a part of the specification.

FIG. 1 illustrates an example network environment, according to some embodiments.

FIG. 2 is a flowchart illustrating a method for preparing a geofence list, according to some embodiments.

FIG. 3 is a flowchart illustrating a method for sending an indication to a user equipment, according to some embodiments.

FIG. 4 illustrates an example computer system, according to some embodiments.

In the drawings, like reference numbers generally indicate identical or similar elements. Additionally, generally, the left-most digit(s) of a reference number identifies the drawing in which the reference number first appears.

### DETAILED DESCRIPTION

Various embodiments of this disclosure will be discussed with respect to the corresponding figures.

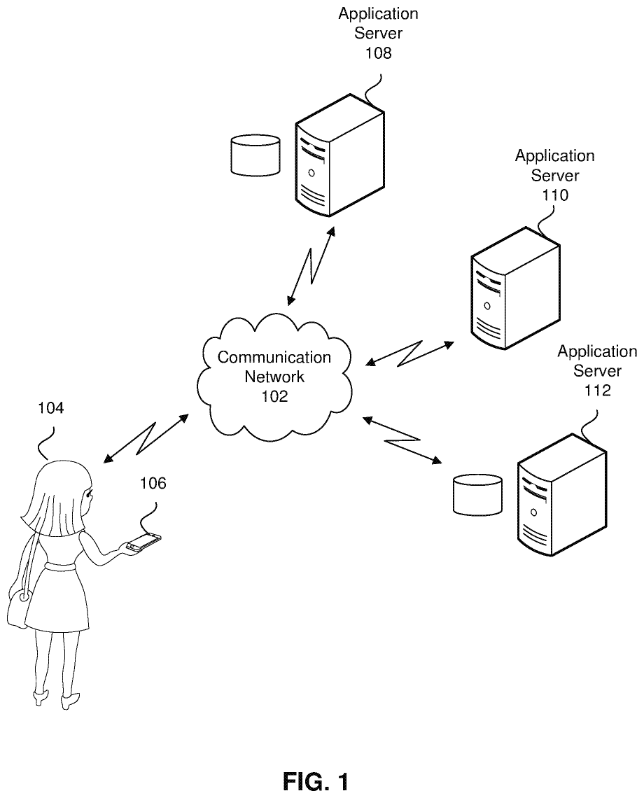

FIG. 1 illustrates an example network environment 100, in which various embodiments described in this disclosure may be practiced. In FIG. 1, a user 104 with a user equipment (UE) 106 is shown. The UE 106 is connected through a communication network 102 to one or more application servers 108, 110, and 112. The one or more application servers 108, 110, and 112 are connected to each other via the communication network 102. The one or more application servers may also include a database; for example, the application servers 108 and 112. Accordingly, the application servers 108 and 112 may be database servers. By way of a non-limiting example, the application servers 108 and 112 may be database servers of one or more car dealerships. This disclosure describes various embodiments using a car dealership and vehicles as an example, but this disclosure is not limited to such examples.

In some embodiments, by way of a non-limiting example, the application server 110 may be an application server that performs as a backend system for a mobile application downloaded on the UE 106. The application server may also operate as the backend system when the user 104 accesses an application running at the application server using the downloaded mobile application, a web interface, or any other interface between the application server 110 and the UE 106. Even though only a single instance of the user 104, the UE 106, and the application servers 108, 110, and 112 are shown in FIG. 1, there may be more than one instance of each communicatively coupled to each other via the communication network 102.

In some embodiments, the UE 106 may be a personal computer, a laptop, a desktop, a tablet, a phone, a smartphone, a smartwatch, etc. The UE 106 may establish a communication with the application server 110 to communicate via the communication network 102. The communication network 102 may provide secure communication between the UE 106 and the one or more application servers 108, 110, and 112 via IPsec and/or other tunneling protocols. The communication network 102 may be a wireline and/or wireless network, that may support communication over 3G, 4G, 5G, 6G, Wi-Fi, a Local Area Network (LAN), a metropolitan area network (MAN), a wide area network (WAN), Wi-Max, a public land mobile network (PLMN), and/or a public switching telephone network (PSTN), etc. By way of non-limiting example, the UE 106 and/or one or more applications running on the UE 106 may communicate with the application server 110 via a secure hypertext transfer protocol (HTTPS) message, a hypertext transfer protocol (HTTP) message, a web service message based on a simple object access protocol (SOAP) and/or a representational state transfer (REST) architecture.

In some embodiments, by way of a non-limiting example, using the mobile application downloaded on the UE 106, the user 104 may send a request over the communication network 102 to the application server 110 for a plurality of inventory items available for purchase. By way of a non-limiting example, the plurality of inventory items may be a plurality of vehicles at a plurality of car dealerships, home appliances at a plurality of retailers, or homes for rent or sale, etc. In this disclosure, embodiments are described using the plurality of vehicles available for purchase at the plurality of car dealerships. Upon receiving the request from the UE 106, the application server may send one or more requests to the application servers 108 and/or 112 to receive information about the available vehicles for purchase. The request from the application 110 to the application servers 108 and/or 112 may be a database query, a secure hypertext transfer protocol (HTTPS) message, a hypertext transfer protocol (HTTP) message, a web service message based on a simple object access protocol (SOAP) and/or a representational state transfer (REST) architecture. A response from the application servers 108 and/or 112 to the request from the application server 110 may be a database query response, another secure hypertext transfer protocol (HTTPS) message, another hypertext transfer protocol (HTTP) message, another web service message based on a simple object access protocol (SOAP) and/or a representational state transfer (REST) architecture. The response from the application servers 108 and/or 112 may include information of the plurality of vehicles. By way of a non-limiting example, the information of the plurality of vehicles may include vehicle make, model, year of manufacture, the color of the vehicle, trim, mileage, etc. The information of the plurality of vehicles may also include physical location information of each of the plurality of vehicles. The physical location information may be provided, for example, using geo-coordinates of the car dealership, and/or a street address of the physical location of the car dealership, etc. The application server may send a response including the information of the plurality vehicles to the UE 106 in response to the request from the UE 106.

In some embodiments, upon receiving the response including the information of the plurality of vehicles, the application running on the UE 106 may display the plurality of vehicles and associated information to the user 104 such that the user 104 can review the received information. The user 104 may select a vehicle from the plurality of vehicles and may save the vehicle information. By way of a non-limiting example, a user profile may be generated based on the user's interaction with the plurality of vehicles. The user profile may be generated based on features such as price range, vehicle class (e.g., midsize, compact, sports utility vehicle, etc.), monthly installment, etc. Thus, the user 104 is presented the plurality of vehicles based on the generated user profile to select a vehicle. As the vehicle information is saved, the physical location information, as received from the application server 110, may be saved by the application running on the UE 106. By way of a non-limiting example, the physical location information of the vehicle of interest may be passed to a native application running on the UE 106, which monitors the physical location of the UE 106.

In some embodiments, the UE 106 may determine the physical location of the UE 106 using global navigation satellite system (GNSS) signals, triangulation of signals from base stations/access points, and/or using a location-based service, etc. A third party service application server may provide the location-based service. Accordingly, when the user 104 with the UE 106 is within a preconfigured threshold distance from the physical location of the car dealership having the vehicle of interest, the native application or the mobile application running on the UE 106 may communicate with the application server 110 regarding the current location of the UE 106 and/or the current location of the vehicle of interest. By way of a non-limiting example, the native application or the mobile application running on the UE 106 may communicate with application server 110 regarding the current location of the UE 106 when the UE 106 remains within the preconfigured threshold distance of the physical location of the car dealership for a preconfigured time period. The application server 110 may send an indication to the UE 106 that the UE 106 is within a vicinity of the vehicle of interest. By way of a non-limiting example, the indication may be a text or short message service (SMS) message, an email, an audible and/or a visual alarm, etc.

In some embodiments, upon receiving the indication suggesting the UE 106 is within the vicinity of the vehicle of interest, the user 104 may act based on the received indication. By way of a non-limiting example, the user 104 may click on the received indication to review the full message. Based on the response of the user 104 to the received indication, the UE 106, through the application running on the UE 106, may transmit the user 104's action in response to the received indication at the UE 106 to the application server 110. The application server 110 may generate a pass and transmit the generated pass to the UE 106.

In some embodiments, by way of a non-limiting example, before the generated pass is pushed to the UE 106, the user 104 may be authenticated using a username and/or a password, biometric information such as a fingerprint, facial features, retina scan, etc. The two-factor authentication system may also be employed to authenticate the user. The pass may include information regarding the vehicle of interest, a prequalification status of the user 104, etc. The prequalification status of the user 104 may include a maximum amount for which the user 104 is prequalified. The pass and/or the prequalification status may be valid for a predetermined time period, for example, one week from the date and time the pass is generated. Accordingly, when the user 104 visits the car dealership and shows the valid pass pushed to the UE 106 by the application server 110, the car dealership may have all relevant information regarding the user 104 to proceed with a purchase transaction. Accordingly, time is saved to complete the purchase transaction. In addition, because the pass also includes the maximum amount for which the user is preapproved and the validity of the pass, the user may visit the dealership before the pass may expire. The user may take advantage of the maximum amount for which the user is preapproved to update search criteria while searching for other vehicles. Similarly, the user may be offered other similar vehicles based on the saved vehicle information and within the maximum amount for which the user is prequalified.

In some embodiments, by way of a non-limiting example, the received pass may be stored in a mobile wallet application. The pass may be a machine-readable image such as a barcode, a quick response (QR) code, etc. The application server 110 may push one or more actions associated with the pass to the UE 106. The one or more actions associated with the pass may be, for example, save the pass to the mobile wallet, set a status reminder on a particular date and time, and/or delete the pass, etc.

In some embodiments, by way of a non-limiting example, the pass may be generated on a per car dealership basis. In this way, multiple vehicles of interest associated with a car dealership may all be included in a single pass. In other embodiments, there may be multiple passes provided to the user where each pass may only include a single-vehicle of interest such that more than one pass may be generated for more than one vehicle of interest associated with a single car dealership. Therefore, if the user 104 has saved more than one vehicle associated with the same or different car dealerships and the user 104 with the UE 106 is within a vicinity of the saved more than one vehicle, the user 104 may receive more than one pass at the UE 106.

In some embodiments, actions of the user 104 may be tracked for statistical purposes. For example, in some embodiments, date and time at which the user 104 marked and saved a vehicle as the vehicle of interest may be logged. In other embodiments, date and time when the user 104 with the UE 106 is within a vicinity of the vehicle of interest may be logged. In another embodiment, a time when an indication from the application server 110 is received at the UE 106, suggesting the user 104 with the UE 106 is within a vicinity of the vehicle of interest may also be logged. In yet another embodiment, if the user 104 responds to the indication received at the UE 106, the date and time corresponding to the user 104′s action and the action taken both may be logged. In an embodiment, if the user visits the dealership and accesses the previously received pass to complete the purchase transaction, the date and time when the pass is accessed may also be recorded. The date and time corresponding to various actions of the user 104 and/or time difference between various actions of the user 104 may be sent to the application server 110 by the UE 106 so that the application server 110 may generate various key performance indicators (KPIs).

In some embodiments, the KPIs that may be calculated to include a percentage of users that had received a push indication, a percentage of users who responded, e.g., opened the pushed indication, and/or when was the pushed indication acted upon relative to sent timestamp. The KPIs may also include information indicating whether the user has accessed the pass, a time difference between when the pass is sent to the UE, and the purchase transaction is completed. These KPIs may help the plurality of car dealerships and/or the application providers to determine the success of the currently available features and/or to provide new features to improve the success rate to meet the expectations.

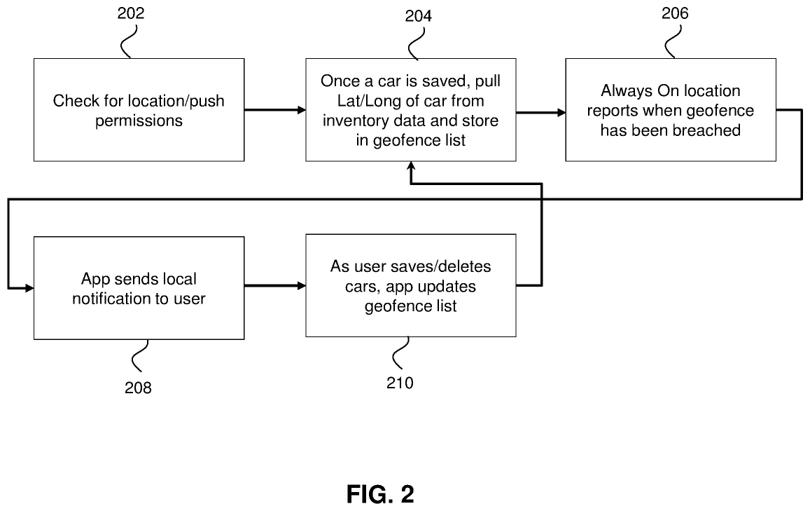

In the above disclosure, various embodiments are performed by the UE 106 in communication with the application server 110. In some embodiments, by way of a non-limiting example, the embodiments may be performed by the UE 106, as shown in FIG. 2. In some embodiments, at step 202, a mobile application running on the UE 106 may check for various permissions, for example, permission to determine or access physical location of the UE 106, and/or a permission to push an indication or a message to an application running on the UE 106. If the user 104 grants permission to determine or access the physical location of the UE 106, the mobile application may receive notifications regarding the physical location of the UE 106. Similarly, if the user 104 grants permission to push the indication or the message to the application running on the UE 106, the application may receive the indication or the message that may provide the user 104 various notifications.

In some embodiments, at step 204, in response to the user 104 saving a vehicle from a plurality of vehicles, a physical location associated with the saved vehicle, i.e., the vehicle of interest, may be extracted and provided to a native mobile application to store in a geofence list. For example, the user may browse the plurality of vehicles received at the UE 106 from the application server 110. The UE may receive information of the plurality of the vehicles in response to a query sent to the application server 110. The query sent to the application server may include filtering criteria, such as vehicle make, vehicle model, year of manufacture, vehicle condition, mileage, etc. The user may select one or more vehicles of the plurality of vehicles that the user is interested in and save this information using the mobile application. The mobile application may save one or more vehicles the user is interested in memory corresponding to the mobile application or the UE 106.

In some embodiments, the user 104 may use a web interface, such as a web browser to browse the plurality of vehicles and save one or more vehicles, as the one or more vehicles of interest. The user 104 may save the vehicles of interest in an online account of the user 104 corresponding to the mobile application. Thus, the user 104 may seamlessly use the mobile application and the web interface.

The geofence list may include a list of physical locations of one or more vehicles of interest. For example, the user 104 may be interested in visiting one or more car dealership of his/her vehicle of interest (s). Accordingly, when the user 104 saves a vehicle, as the vehicle of interest, one or more physical locations having the vehicle of interest may be determined and those physical locations may be stored in the geofence list. In an embodiment, the geofence list is dynamically updated based on parameters set by the user such as geographic area of interest. In another embodiment, the geofence list is dynamically updated based on geographic information provided by a car dealership. Accordingly, when the user 104 is within a predetermined threshold distance of the physical location of the vehicle of interest, the user 104 may be notified that he/she is within the predetermined threshold distance of the physical location of the vehicle of interest. By way of a non-limiting example, the predetermined threshold distance may be a default value set for the native application or the mobile application running on the UE 106. The predetermined threshold distance may be set by the user 104. By way of a non-limiting example, the predetermined threshold distance may be provided as a radius in miles.

In some embodiments, by way of a non-limiting example, information about the vehicle of interest may be stored along with the physical location of the vehicle of interest in the geofence list. The physical location of the vehicle of interest, for example, maybe either coordinates or latitude and longitude of the car dealership where the vehicle of interest may be located. The application server 110 may include the physical location information for each vehicle of the plurality of vehicles as received from the application servers 108 and/or 112. In some cases, the application server may supplement the information received from the application servers 108 and/or 112 to include the physical location information based on the name and physical address of the car dealership for each vehicle of the plurality of vehicles. Thus, the information about the vehicle of interest may include, for example, vehicle information such as vehicle make, model, year of manufacture, color, trim, vehicle condition, mileage, etc., along with physical location information of the vehicle of interest.

In some embodiments, at step 206, based on the permission granted by the user 104 at step 202, when the user 104 is within a preconfigured threshold distance of the saved physical location of the vehicle of interest in the geofence list, a geofence may be considered as breached. As described above, the UE 106 may determine the physical location of the UE 106 using global navigation satellite system (GNSS) signals, triangulation of signals from base stations/access points, and/or using a location-based service, etc. A third party service application server may provide the location-based service. Accordingly, when the user 104 with the UE 106 is within a preconfigured threshold distance from the physical location of the car dealership having the vehicle of interest, the physical location of the UE 106 or the user 104 may be determined and compared against one or more physical locations stored in the geofence list to determine if the UE 106 breached the geofence list with reference to the physical location stored in the geofence list. By way of a non-limiting example, it may be required that the UE 106 may be required to be within the preconfigured threshold distance of the saved physical location of the vehicle of interest for a preconfigured time period before the geofence may be considered as breached. Further, the UE 106 may determine the physical location of the UE 106 at a predetermined time interval points.

In some embodiments, at step 208, the native application may send an indication to the application running on the UE 106 so that the user 104 can be notified that the user 104 is within the vicinity of the vehicle of interest, and the user 104 may visit the car. As described above with reference to FIG. 1, the pass may be pushed to the UE 106 based on the action taken by the user 104 in response to the received indication at step 208.

By way of a non-limiting example, the pass pushed to the UE 106 may include the prequalification status of the user. The prequalification status may include information for one or more vehicles for which the user may qualify based on the generated user profile and the user's interaction with the plurality of vehicles. Thus, the pass pushed to the UE 106 may include one or more vehicles, which the user has not saved as a vehicle of interest. For example, a comparision of a selected vehicle of interest can be compared with an inventory of vehicles to determine vehicles that have matching characteristics to the selected vehicle of interest. A match can be based on similarities between the vehicles such as vehicle type, vehicle price, manufacturer year, etc.

In some embodiments, at step 210, the geofence list may be updated as more vehicles are added as vehicles of interest or a vehicle is removed and no longer a vehicle of interest to the user 104. In other words, the mobile application or the native application may add to or remove from the geofence list the physical location expressed using longitude and latitude of the physical location of the car dealership or the vehicle of interest as a new vehicle of interest is added or existing vehicle of interest is removed.

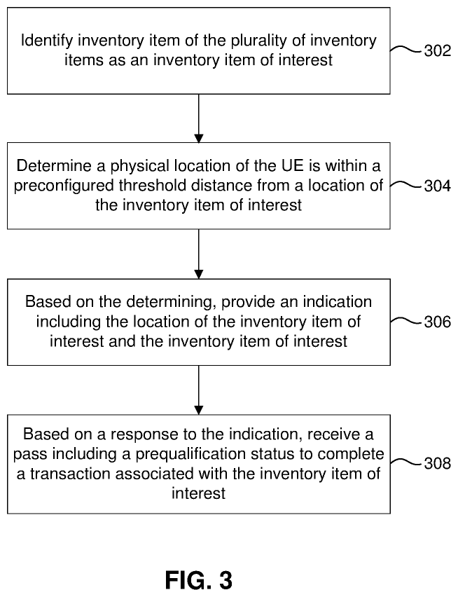

FIG. 3 is a flowchart illustrating a method for pushing a notification corresponding to an inventory item of interest when a geofence is broken, according to some embodiments. An application server, such as the application server 110, may perform the method steps shown in FIG. 3. As shown in FIG. 3, at step 302, an inventory item of a plurality of inventory items may be identified as an inventory item of interest. As described above, with reference to FIG. 1, the user may send a request for the plurality of inventory items available for purchase, such as a plurality of vehicles at a plurality of car dealerships, home appliances at a plurality of retailers, or homes for rent or sale, etc. Upon receiving the request, a response may be prepared that includes the plurality of inventory items and information associated with each inventory item of the plurality of inventory items. Accordingly, the user may browse the plurality of inventory items and select an inventory item, which the user is interested. As described above, the physical location of the inventory item of interest may be saved, for example, in the geofence list.

In some embodiments, at step 304, a physical location of the UE may be determined as being within a preconfigured threshold distance from the physical location of the inventory item of interest. As described above, the physical location of the UE may be determined using global navigation satellite system (GNSS) signals, triangulation of signals from base stations/access points, and/or using a location-based service, etc. A third party service application server may provide the location-based service. Further, as described above, in response to the user saving the selected inventory item as the inventory item of interest, physical location information may be extracted from the information received. The physical location information may be in the form of, for example, longitude and latitude, and can be provided to the native application running on the UE. The native application running on the UE may save the longitude and latitude in the geofence list. Since the native application is periodically monitoring the location of the UE, it may be determined when the UE is within a predetermined distance from the physical location information saved in the geofence list.

In some embodiments, at step 306, based on the determined location of the UE 106, an indication may be sent to the UE 106. As described above, at step 304, the native application running on the UE may determine that the UE is within a predetermined distance from the physical location of the inventory item of interest and may notify the mobile application running on the UE. The mobile application running on the UE may then communicate the UE'ss location as within a predetermined threshold distance from the physical location of the inventory item of interest to the application server. Accordingly, the application server may push the indication to the UE 106, where the pushed indication may include the inventory item of interest and the physical location of the inventory item of interest. In some embodiments, at step 308, based on the response of the user 104 to the indication, a pass may be pushed to the UE 106 as described above.

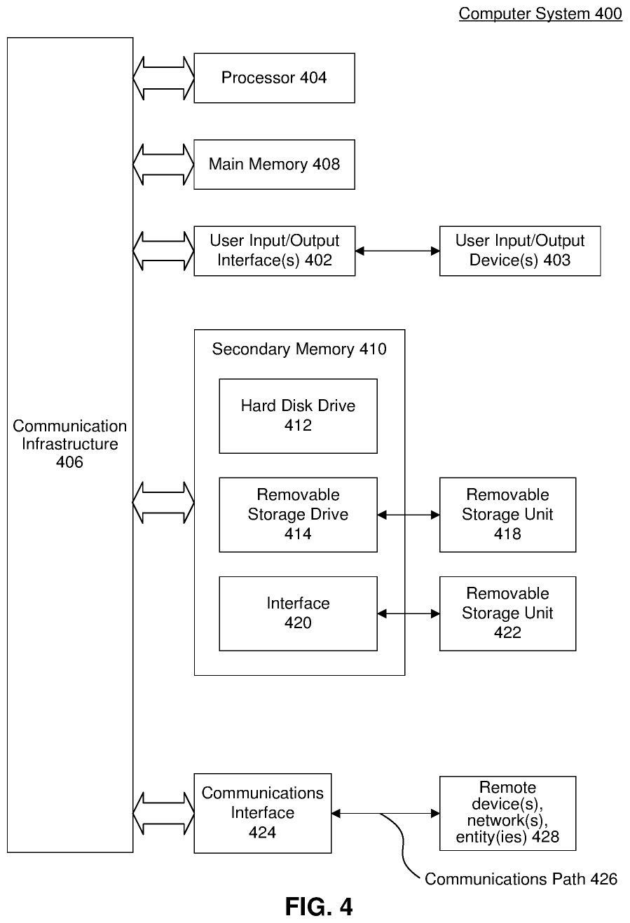

FIG. 4 illustrates an example computer system in accordance with some embodiments.

Various embodiments may be implemented, for example, using one or more well-known computer systems, such as a computer system 400, as shown in FIG. 4. One or more computer systems 400 may be used, for example, to implement any of the embodiments discussed herein, as well as combinations and sub-combinations thereof. The computer systems 400 may be used for the implementation of one or more embodiments described above.

The computer system 400 may include one or more processors (also called central processing units, or CPUs), such as a processor 404. The processor 404 may be connected to a communication infrastructure or bus 406.

The computer system 400 may also include user input/output device(s) 403, such as monitors, keyboards, pointing devices, etc., which may communicate with communication infrastructure 406 through user input/output interface(s) 402.

One or more processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

The computer system 400 may also include a main or primary memory 408, such as random access memory (RAM). Main memory 408 may include one or more levels of cache. Main memory 408 may have stored therein control logic (i.e., computer software) and/or data.

The computer system 400 may also include one or more secondary storage devices or memory 410. The secondary memory 410 may include, for example, a hard disk drive 412 and/or a removable storage device or drive 414. The removable storage drive 414 may be a floppy disk drive, a magnetic tape drive, a compact disk drive, an optical storage device, tape backup device, and/or any other storage device or storage drive.

The removable storage drive 414 may interact with a removable storage unit 418.

The removable storage unit 418 may include a computer-usable or readable storage device having stored thereon computer software (control logic) and/or data. The removable storage unit 418 may be a floppy disk, magnetic tape, compact disk, DVD, optical storage disk, and/any other computer data storage device. The removable storage drive 414 may read from and/or write to the removable storage unit 418.

The secondary memory 410 may include other means, devices, components, instrumentalities, or other approaches for allowing computer programs and/or other instructions and/or data to be accessed by the computer system 400. Such means, devices, components, instrumentalities, or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

The computer system 400 may further include a communication or network interface 424. The communication interface 424 may enable the computer system 400 to communicate and interact with any combination of external devices, external networks, external entities, etc. (individually and collectively referenced by reference number 428). For example, the communication interface 424 may allow the computer system 400 to communicate with the external or remote devices 428 over communications path 426, which may be wired and/or wireless (or a combination thereof), and which may include any combination of LANs, WANs, the Internet, etc. Control logic and/or data may be transmitted to and from the computer system 400 via the communication path 426.

The computer system 400 may also be any of a personal digital assistant (PDA), desktop workstation, laptop or notebook computer, netbook, tablet, smartphone, smartwatch or another wearable, appliance, part of the Internet-of-Things, and/or embedded system, to name a few non-limiting examples, or any combination thereof

The computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in the computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats, or schemas may be used, either exclusively or in combination with known or open standards.

In accordance with some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, the computer system 400, the main memory 408, the secondary memory 410, and the removable storage units 418 and 422, as well as tangible articles of manufacture embodying any combination of the foregoing. Such control logic, when executed by one or more data processing devices (such as the computer system 400), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system implementations other than those described herein.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments but should be defined only in accordance with the following claims and their equivalents.

1. A method, comprising:
identifying, by an application server, an inventory item of a plurality of inventory items as an inventory item of interest;
receiving, at the application server from a user equipment (UE), a data signal including current physical location of the UE that is determined using a location-based service;;
extracting, at the application server, the current physical location of the UE, from the data signal;
determining, by the application server, the current physical location of the UE is within a preconfigured threshold distance from a location of the inventory item of interest;
based on the determining, providing, from the application server to the UE, an indication comprising the location of the inventory item of interest and the inventory item of interest; and
based on a response to the indication, receiving, from the application server at the UE, a pass comprising a prequalification status to complete a transaction associated with the inventory item of interest.

2. The method of claim 1, further comprising:
setting the pass to be stored in a mobile wallet on the UE for a predetermined time duration.

3. The method of claim 1, further comprising:
based on the response to the indication, authenticating a user of the UE to receive the pass from an application server.

4. The method of claim 1, further comprising:
providing the pass and one or more actions associated with the pass for displaying on a display of the UE.

5. The method of claim 1,
wherein the pass comprises a machine-readable image.

6. The method of claim 1, further comprising:
sending, to the UE, a second pass comprising a prequalification status corresponding to a second inventory item of interest to complete a transaction associated with the second inventory item of interest.

7. The method of claim 1, further comprising:
receiving a type of the response to the indication and a time difference between the displaying the indication and the response to the indication at the application server.

8. The method of claim 1, further comprising:
retrieving, at the application server, physical location information of the inventory item of interest; and
monitoring the physical location of the UE using a location-based service to determine whether UE is within the preconfigured threshold distance of the location of the inventory item of interest.

9. The method of claim 1, wherein providing the indication comprises:
in response to determining that the UE is within the preconfigured threshold distance of the location of the inventory item of interest, pushing the indication to the UE.

10. A system, comprising:
a memory for storing operations; and
one or more processors, communicatively coupled to the memory, configured to perform the operations comprising:
providing a plurality of inventory items for selecting an inventory item as an inventory item of interest;
identifying the inventory item of interest and a physical location corresponding to the inventory item of interest;
receiving, from a user equipment (UE), a data signal including a current physical location of the UE that is determined using a location-based service;
extracting the current physical location of the UE, from the data signal;
determining the current physical location of the UE is within a preconfigured threshold distance from the physical location corresponding to the inventory item of interest;
in response to determining the current physical location of the UE is within a preconfigured threshold distance from the physical location corresponding to the inventory item of interest, providing an indication comprising the location of the inventory item of interest and the inventory item of interest; and
based on a response to the indication, pushing a pass to the UE, wherein the pass that comprises a prequalification status to complete a transaction associated with the inventory item of interest.

11. The system of claim 10, wherein the operations further comprise:
based on the response to the indication, authenticating a user of the UE to push the pass to the UE.

12. The system of claim 10, wherein the operations further comprise:
transmitting one or more actions associated with the pass to the UE for displaying on a UE display to allow a user interaction.

13. The system of claim 10, wherein the operations further comprise:
pushing the pass as a machine-readable image to the UE.

14. The system of claim 10, wherein the operations further comprise:
pushing a second pass comprising a prequalification status corresponding to a second inventory item of interest to complete a transaction associated with the second inventory item of interest.

15. The system of claim 10, wherein the operations further comprise:
receiving a type of the response to the indication and a time difference between the displaying the indication and the response to the indication at the application server.

16. A non-transitory, tangible computer-readable device having instructions stored thereon that, when executed by at least one computing device of an application server, causes the at least one computing device to perform operations comprising:
identifying an inventory item of a plurality of inventory items as an inventory item of interest;
receiving, from a user equipment (UE), a data signal including a current physical location of the UE that is determined using a location-based service;
extracting the current physical location of the UE, from the data signal;
determining the current physical location of the UE is within a preconfigured threshold distance from a location of the inventory item of interest;
based on the determining, providing, to the UE, an indication comprising the location of the inventory item of interest and the inventory item of interest; and
based on a response to the indication, pushing a pass comprising a prequalification status to complete a transaction associated with the inventory item of interest.

17. The non-transitory, tangible computer-readable device of claim 16, wherein the operations further comprise:
setting the pass to be stored in a mobile wallet on the UE for a predetermined time duration.

18. The non-transitory, tangible computer-readable device of claim 16, wherein the operations further comprise:
providing the pass and one or more actions associated with the pass for displaying on the UE display,
wherein the pass comprises a machine-readable image.

19. The non-transitory, tangible computer-readable device of claim 16, wherein the operations further comprise:
sending a second pass comprising a prequalification status corresponding to a second inventory item of interest to complete a transaction associated with the second inventory item of interest.

20. The non-transitory, tangible computer-readable device of claim 16, wherein the operations further comprise:
receiving a type of the response to the indication and a time difference between the displaying the indication and the response to the indication at the application server.
